(19) United States
(12) Patent Application Publication
(10) Pub. No.: US 2007/0206370 A1
(43) Pub. Date: Sep. 6, 2007

(54) Low Power LED-Fluorescent Lighting System

(75) Inventor: PAUL CRUNK, TAYLOR, MI (US)

Correspondence Address: PAUL CRUNK, 12220 WOODCREST, BOX 725, TAYLOR, MI, 48180, US

(73) Assignee: PAUL CRUNK, TAYLOR, MI (US)

(21) Appl. No.: 11/308,063

(22) Filed: Mar. 5, 2006

(51) Int. Cl. G03B 15/02

(52) U.S. Cl. 362/4

(57) ABSTRACT

A lighting system for LED or some fluorescent lighting consisting of a power supply/transformer converting AC power 110-130 Volts or AC 220-240 Volts to low-power 2 VAC or higher or a power supply transformer converting 2 VDC or higher to 2 VAC or higher, which can be used to operate fluorescent or LED lighting of any shape or size and configuration containing one or more fluorescent or LEDs bulbs inside each light, which can be used to illuminate or detail homes, businesses, apartments, recreational vehicle's, campers, mining, marine applications, campers, horse trailers, military applications, horse drawn buggy, Amish buildings and housing, commercial retail stores and businesses etc to illuminate stationary building structures interior or exterior or can be used if different types of a vehicles and trailers used to transport humans, products, animal or materials cutting the power consumption by 50% or higher.

A complete low power lighting system consisting of a power supply-transformer having connected to it all different types of fluorescent lighting or standard everyday LED lighting that are currently being used in all type of markets, including the trucking, automobile motorcycle home and business lighting industry today. In the vehicle lighting industry these LED lights are currently controlled by a 2-48 VDC battery type system. Some fluorescent lighting or LED lighting in the vehicle lighting industry have internal drivers to convert a DC power wave into an AC power wave allowing the fluorescent or LED lighting to run brighter and cooler. But with the TMI LED low power lighting system we have changed it by converting 120 VAC to a low-power AC current power wave, which output power which can be from 2 Volts and up and this system is 100% safe for most all existing led lights which can illuminate as well as provide high brightness and beauty in light detailing, which allows the lights to consumes 50 to 99.9% less power taking the world off the dependency of foreign oil.

### BRIEF DESCRIPTION OF DRAWINGS

FIG. 1 Shows a power supply transformer 1 with output voltage protection.

FIG. 2 Shows a fuse with two small metal fuse end caps with L-shape pin attached to one end cap.

FIG. 3 Shows a small PCB with copper track to mount fuse clip and attach wire from controller.

FIG. 4 Shows a controller PCB with two output pins that talks power out to the lighting that is attached to the system.

FIG. 5 Shows a round dome shape light which can be surface mounted with out the use of any screws using simply glue, hot glue or 3M double back tape.

FIG. 6 Shows a example of one rectangle light which can be of any size or design with any type pattern on the interior or exterior of the lens, which also offers two mounting holes outside the lens to be able to mount it to a surface without removal of the lens.

FIG. 7 Shows a large 4″ round light with any number of LEDs inside that can be recessed or surface mounted using different mounting fixtures.

FIG. 8 Shows an oval light with any number of LEDs inside that can be recessed or surface mounted using different mounting fixtures.

FIG. 9 Show a simple wiring hookup of simple led lights attached to two wires and the two wires wire attached to the power supply/transformer having a photo cell on a third cable, a control dial to choose a setting to control when the lights come on and off and a fuse or a pop button fuse to offer output voltage protection to the lights.

FIG. 10 Shows an example of a round light containing one or more LEDs, which can be facing forward or sideways to create light patterns on a building, a vehicle, a structure or the ground creating a decorative effect pattern of light.

FIG. 11 Shows a surface mounting type of light with two mounting holes that are on the outside all of the light allowing the consumer easy installation without a lens removal to mount the light and a lens that can contain patterns on the inside or exterior of the lens that will take the LED light being generated by the LEDs to create a beautiful decorative pattern of illuminating light.

FIG. 12 Shows another type of surface mounting light were the lens is removal were the screws go through the inside of the light using mounting holes where the light can be mounted to a surface area using screws, glue, hot glue 3M tape without seeing any invisible mounting screws and were the lens is fully removal for installation and can be reassembled onto the base allowing a beautiful looking light with out any visible mounting screws to be seen.

### DETAILED DESCRIPTION OF DRAWINGS

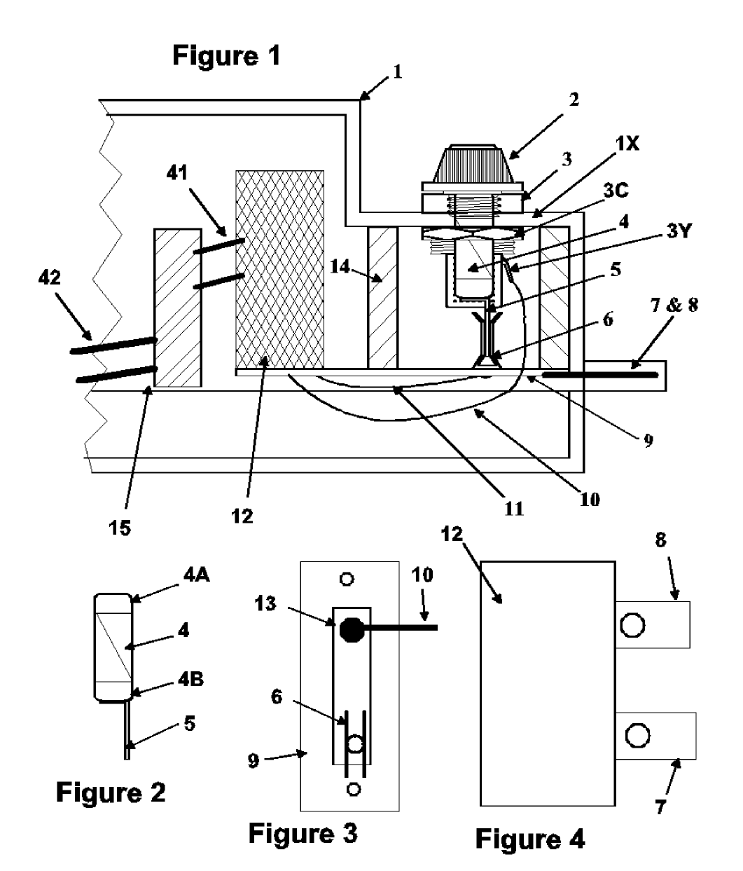

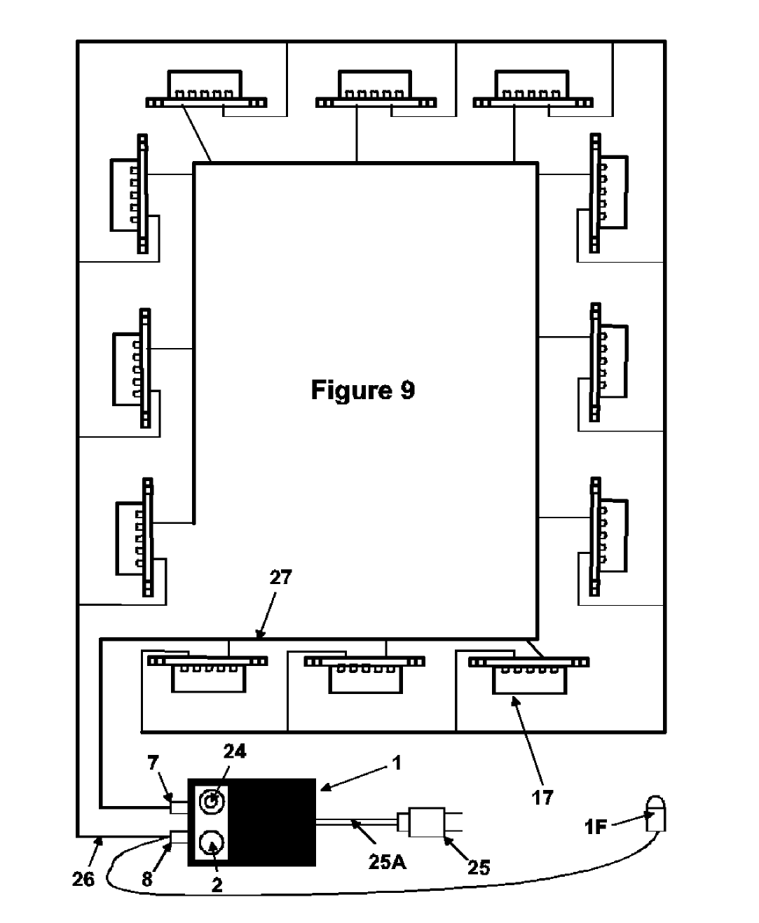

FIG. 1 Shows a power supply transformer 1 with output over voltage protection fuse 4 inserted into fuse holder 3 with screw base and securing nut 3C, which fuse holder 3 is inserted through the body of the power supply transformer 1x which is held in place in the preferred way by a nut 3C securely holding the fuse holder 3 in place though the case of the power supply transformer body 1x which fuse 4 inserts into fuse Holder 3 where the fuse end cap 4A inserts inside fuse cap 2, which 2 screws into the holder 3 holding fuse 4 inside the fuse holder 3 using fuse cap 2. The fuse 4 has an L-shaped type pin 5 attached to one end of the fuse cap 4B which allows the fuse pin 5 to insert through the bottom all of fuse holder 3 into clip 6 which is securely mounted to PCB 9 where power flows across the copper track 13 to the clip 6 where the wire 11 takes power back and forth through the controller PCB 12 were controller PCB 12 also having a second wire attached takes power to wire 10 to connector 3Y mounted into fuse holder 3 into fuse 4 end cap 4A which allows the power to flow through the fuse 4 and wires 11 and 10 using fuse 4 as an over voltage protection device on the output side of the controller PCB 12 mounted inside the case of the power supply/transformer. On PCB 9 shows two connectors 7 & 8 that allow the lighting to be attached thereto using wires with connectors that slide over 7 & 8. Also seen is the ballast 15 that is connected to controller PCB 12 using a pair of wires 41 with a pair of wires that have attached on the end a male wall plug connector 25 in FIG. 8.

FIG. 2 Shows a fuse 4 with two metal end caps 4A and 4B with L-shape pin attached to one end cap 4B.

FIG. 3 Shows the small PCB 9 with copper track 13 where wire 10 attaches to the copper track at 13A and clip 6 attaches to the same copper track 13 and have two mounting holes 9A and 9B to mount PCB inside of the power supply/transformer.

FIG. 4 Shows a controller PCB 12 with two output pins 7 and 8 that goes out to the lighting that is attached to the system.

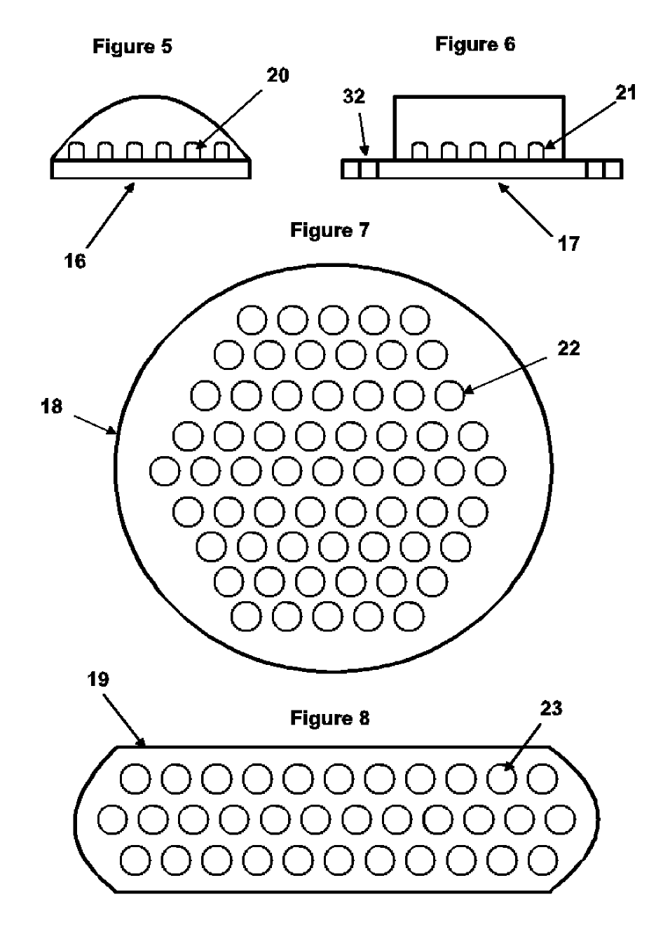

FIG. 5 Shows a round dome shape LED light 16 with led 20 inside that can be surface mounted with out the use of any screws by just using glue or 3M double back tape.

FIG. 6 Shows a rectangle light 17 with any type pattern on the lens with led 21 inside and two mounting holes 32 to be able to mount it to a surface.

FIG. 7 Shows a large 4″ round light 18 with LEDs 16 inside, which can contain 1 or more or if required that can mount recessed or on the surface of the application using different mounting fixtures found in the world market.

FIG. 8 Shows an oval shape LED light 19 with nineteen LEDs 23 inside which can be more or less if required that can mount recessed or on the surface of the application using different types mounting fixtures found in the world market.

FIG. 9 Shows a simple hookup using led lights 17 attached to wire 27 and 26 that attaches to connectors 7 & 8 out the end of the power supply/transformer 1 having a photo cell 1F on the end of cable attached to power supply/transformer 1 and transformer also having a control dial 24 to choose OFF, ON, AUTO, 4H, 6H and 8H setting to control when the light come on and off. The power supply/transformer 1 also offers an over voltage protection using a thermal fuse or a pop button fuse 2 mounted into the case for easy accessibility to reset or replace.

The power supply/transformer 1 also has a power cord 25A permanently attached to the power supply/transformer 1 with preferably a male a plug 25 on the end of the cord for easy to plug in to a wall outlet.

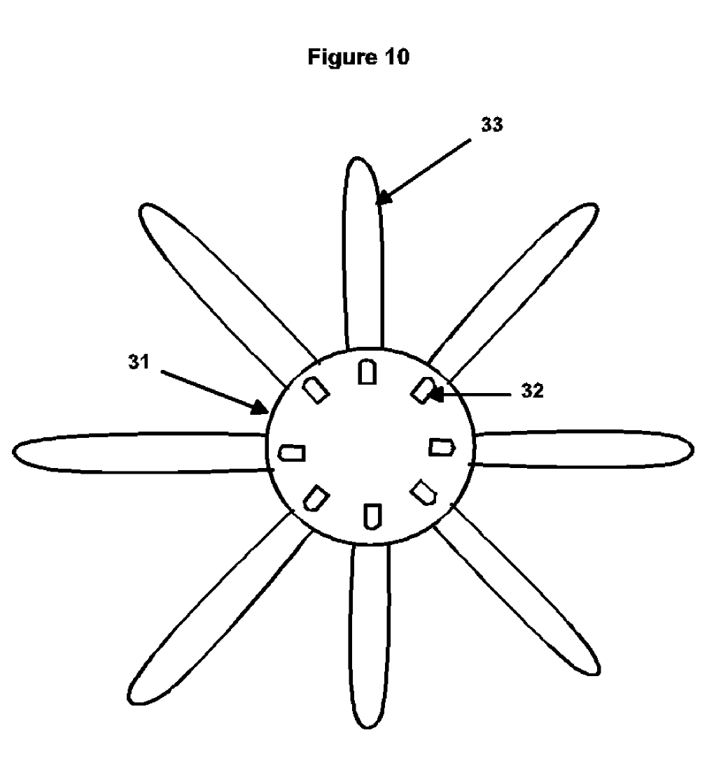

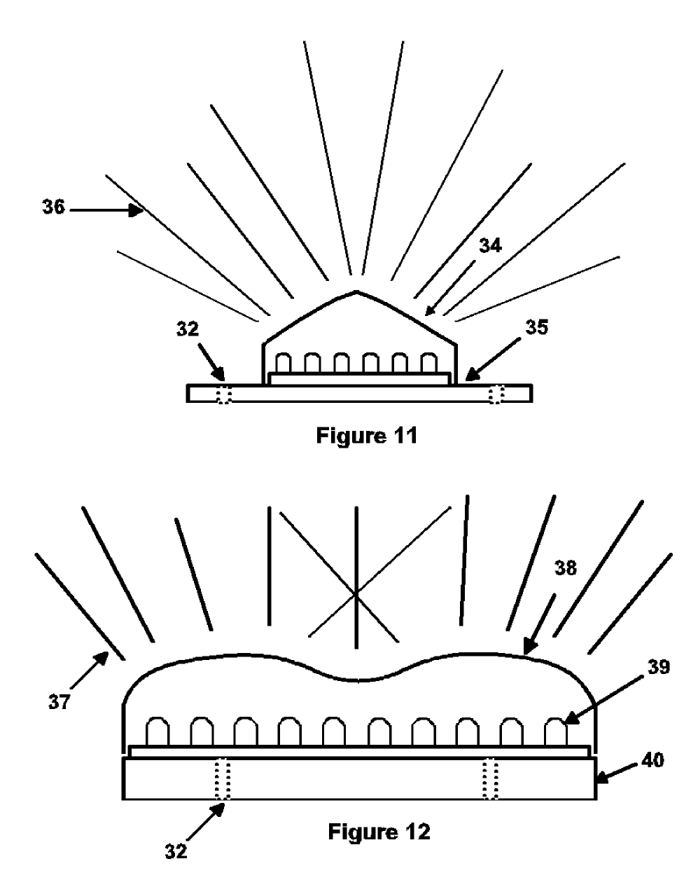

FIG. 10 Shows a example of a round light 31 containing one or more LEDs 32, which can be facing forward or sideways, which can create light patterns on a building, inside or outside a vehicle or stationary structure or on the ground creating a decorative pattern of light. The round light 31 is only one of many types of models of LED lights that can be used to produce beautiful types of light patterns for decorative purpose and illuminating inside or outside of homes, businesses or commercial buildings and structures using the power supply/transformer.

FIG. 11 Shows a surface mounting type of light 35 with two mounting holes 32 that are on the outside all of the light allowing the consumer easy installation without the removal of a lens to mount the light 35, which the light 35 has a lens that can contain patterns on the inside or exterior of the lens that will capture the LED light being generated by the LEDs to bend and create a beautiful decorative pattern of illuminating light in different patterns depending on the size, shape and brightness of the LEDs being used and the pattern of the lens.

FIG. 12 Shows another type of surface mounting LED light 40 were the lens 38 is removal were the screws goes through the inside of the light using mounting holes 32 where the light can be mounted to a surface area without seeing any invisible mounting screws and were the lens is fully removal for installation and can be reassembled onto the base allowing a beautiful looking light with out any visible mounting screws to be seen.

What is claimed is:

1. LED lighting of any shape size or design sealed or none sealed that can operate on a low power DC or AC power supply/transformer to be used in any stationary or not stationary applications including residential, business, commercial applications, marine, any vehicle or solar powered, battery powered that can be used interior or exterior to produce visible light directly or indirectly for beauty or visible light and having a photo cell that can turn on and off the light automatically during sunrise and sunset each day.

2. A power supply/transformer that can convert standard 110-130 VAC or 220-240 VAC to 2V DC/AC or higher with a safety input circuit to prevent high power input into the power supply transformer from spikes or overpower and safety out put circuit to protect and prevent output overloading thus preventing fires of having too many lights being loaded onto the lighting system or if at any time an animal or human would ever happen to short-circuit the electrical wiring in the lighting system would trip a resettable or replaceable type safety device/fuse if the system was ever short circuited or overloaded.

3. A power supply/transformer that can convert DC 2 volts or higher into AC 2 volts or higher with a safety circuit to prevent high power input into the power supply transformer from spikes or overpower and safety output circuit protection to prevent output overloading to prevent fires of having too many lights being loaded onto the lighting system or if at any time an animal or human would ever happen to short-circuit the electrical wiring in the lighting system would trip a resettable or replaceable type safety device/fuse if the system was ever short circuited or overloaded and having a photo cell that can turn on and off the light automatically during sunrise and sunset each day.

4. A power supply transformer acting as the driver to power one or more types of fluorescent or LED lighting of any type configuration, which will allow them to reach the maximum brightness and allow them to run cooler preventing and reducing eminent lighting failure, which DC power from a battery or power supply transformer does create, because of the DC wave, where the AC wave current is a pulsating effect type wave, which can convert 50 HZ to 60 Hz to 60 Hz or higher to help eliminate the visible flickering to the human or animal eye in the low power AC lighting type lighting system to drive LED lighting or miniature fluorescent lighting of any color shape or size and having a photo cell that can turn on and off the light automatically during sunrise and sunset each day.

5. To use any type design color LED light manufactured by any company with any type led shape size or color manufactured worldwide currently used in all non stationary vehicle lighting or stationary lighting used in home, businesses, commercial, which can be hooked up as part of this low power lighting system to illuminate or detail, which is 100% safe for the input and output power to be used in any type or lower power lighting application worldwide allowing 100% safety to the end-user because the power supply/transformer comes equipped with an internal safety tripping device preventing a chance of electrical wiring or the lighting device failing or catching fire, because of a device failure, error in consumer installation, accidental short circuit, animal teeth chewing into the wiring or any other possible way that would cause an electrical failure in the lighting system.
